(19) United States
(12) Patent Application Publication
(10) Pub. No.: US 2013/0246241 A1
(43) Pub. Date: Sep. 19, 2013

(54) Dynamic Slicer Order Scheduling and Analysis Tool

(71) Applicant: TRADING TECHNOLOGIES INTERNATIONAL, INC., (US)

(72) Inventors: William Tigard Baker, Hoffman Estates, IL (US); Bevan Jacob Brookfield, Evanston, IL (US); Tom James Haldes, Chicago, IL (US); Andrew Theodore Renalds, Chicago, IL (US); Iliar Mangutov, Hinsdale, IL (US)

(73) Assignee: TRADING TECHNOLOGIES INTERNATIONAL, INC., Chicago, IL (US)

(21) Appl. No.: 13/737,715

(22) Filed: Jan. 9, 2013

Related U.S. Application Data
(60) Provisional application No. 61/610,858, filed on Mar. 14, 2012.

(51) Int. Cl. G06Q 40/04

(52) U.S. Cl. CPC G06Q 40/04
USPC 705/37

(57) ABSTRACT

A tool and method for dynamically managing and executing slicer order is disclosed. The tool and method provide a mechanism by which component parts of the slicer order such as the parent order and one or more child orders can be modified while the slicer order is executing according to a slicer plan. Modification of the executing slicer order results in an analysis and recalculation of the slicer plan to accommodate the requested modification(s).

### CROSS REFERENCE TO RELATED APPLICATIONS

This patent document claims the priority benefit of U.S. Provisional Application No. 61/610,858, filed Mar. 14, 2012, entitled “Dynamic Slicer Order Scheduling and Analysis Tool,” the contents of which are fully incorporated herein by reference.

This patent document is related to U.S. patent application Ser. No. 13/416,561, filed Mar. 9, 2012, entitled “Slicing Order Quantity Reduction Tool,” the contents of which are fully incorporated herein by reference.

### BACKGROUND

An electronic trading system generally includes one or more trading devices in communication with an electronic exchange. The electronic exchange sends information about a market, such as prices and quantities, to the trading device. Trading devices send messages, such as messages related to orders, to the electronic exchange. The electronic exchange attempts to match quantity of an order with quantity of one or more contra-side orders.

A slicer order is a synthetic strategy that involves breaking or slicing one order into multiple component orders that are traded separately. For example, an order may be time sliced and/or volume sliced. Slicer orders may be utilized to, for example, reduce a market impact when a total desired quantity of an order is large relative to market liquidity.

### BRIEF DESCRIPTION OF THE DRAWINGS

Exemplary embodiments are disclosed with reference to the following drawings.

FIG. 1 illustrates a block diagram of an exemplary electronic trading system in which certain embodiments disclosed herein may be employed.

FIG. 2 illustrates a block diagram of an exemplary computing device that may be utilized in connection with the electronic trading system show in FIG. 1.

FIG. 3A illustrates an exemplary graphical user interface (GUI) showing an exemplary slicer order status at a first time; and FIG. 3B illustrates the slicer order status of FIG. 3A at a second time.

FIG. 4 illustrates a block diagram of an exemplary apparatus for dynamically analyzing and scheduling components of slicer orders.

FIGS. 5A to 5D illustrate flow diagrams of exemplary processes executed to perform the dynamic analysis and scheduling functionality.

FIGS. 6A to 6D illustrate operational examples of an exemplary apparatus for dynamically analyzing and scheduling components of slicer orders.

The disclosed and discussed embodiments, features and advantages will be better understood when read in conjunction with the provided drawings, which illustrate examples. It should be understood, however, that the embodiments are not limited to the arrangements and instrumentality shown in the attached drawings.

### DETAILED DESCRIPTION

### I. Brief Description of Certain Embodiments

The disclosed embodiments generally relate to a dynamic slicer order analysis and scheduling tool. A slicer order is a synthetic strategy that involves breaking or slicing one order into multiple component orders that are traded separately. A trading device may formulate how to slice one order into multiple component orders and execute those component orders based on instructions provided by a user. The order to be sliced is referred to herein as a parent order, while the component orders into which the parent order is sliced are referred to herein as child orders. The parent order has a quantity that is broken down into component quantities in the child orders that add up to the parent quantity. The individual child orders, in turn, are sent to the market according to a slicer plan.

There are different types of slicer orders including, for example, time slicer orders and volume slicer orders. Depending on a type of slicer order, each of the individual child orders is triggered (for example, sent to a market or an exchange) by one or more events or conditions in accordance with the pre-defined plan. For example, the child orders of a time slicer order can be sent to one or more markets when a respective time interval is reached. In such instances, each time a clock reaches a time interval defined in the time slicer order as a trigger, a trading device sends one or more of the individual child orders to the market(s). In operation, an exemplary time slicer order may be defined such that one of the child orders is sent every five or ten minutes. In another example, the child orders of a volume slicer order can be sent to one or more markets when the market(s) experiences a designated trading volume. In such instances, one or more child orders of a volume slicer order are sent to the market(s) when the market(s) for which the child order(s) are destined have sufficient activity (as defined in settings associated with the volume slicer order, for example). For example, a volume slicer order may be defined such that one of the child orders is sent each time the destination market trades five hundred of the corresponding tradeable object. Other types of triggering conditions or events are possible for slicer orders. For example, child orders may be triggered by an amount of rainfall in a particular region, by daily temperature readings in a particular region, etc. Additionally or alternatively, a slicer order (of any type) could be configured to respond to user input to send one or more child orders at a non-scheduled time or a time not automatically triggered by, for example, a preconfigured triggering event. In other words, the user can trigger conveyance of one or more child orders to one or more markets at any time.

Slicer orders may be utilized by a user to, for example, reduce the market impact when a total desired quantity of a desired order is large relative to the market liquidity. If an order is large enough, placement of the order on a market may adversely impact the effective price. In such instances, a time slicer order can be utilized to break the large order into a plurality of relatively smaller child orders that are individually less likely to adversely impact the respective market than the larger parent order. Additionally or alternatively, a volume slicer order can be utilized to place child orders into a market based on volume of activity at the market. These and other types of slicer orders can be utilized to implement additional or alternative strategies or to achieve additional or alternative benefits.

The disclosed and described embodiments of the dynamic slicer order analysis and scheduling tool provide a mechanism by which the individual elements of a slicer order such as the parent order or the individual child orders, can be modified while active in the market. For example, in response to a change in the timing or quantity of one of the elements of the slicer order, the exemplary dynamic slicer order analysis and scheduling tool may analyze the change and generate a new schedule or plan by which the slicer order may be implemented in the market. In this way, the tool provides a mechanism by which a user can dynamically adjust and manipulate the operation of the slicer order in response to changing market conditions, customer requirements or any other desired condition.

Embodiments disclosed herein relate to, for example, dynamically manipulating the total quantity of a parent order, the individual quantity of a child order, the individual price of a child order, the timing or interval at which child orders are placed in the market in response to a request received from a user of the trading device. To enable such dynamic changes, the disclosed tool analyzes the user-requested change as a function of one or more user-specified slicer parameters such as the placement interval, the overall duration, and the disclosed quantity and calculates a new plan and schedule by which the individual child orders are to be worked in the market to achieve the desired user request. Slicer parameters can be fixed or locked parameters such as the overall duration slicer parameter for duration type slicer orders, and are not modified when calculating a modified slicer plan.

Although the following discloses embodiments including, among other components, software executed on hardware, it should be noted that the embodiments are merely illustrative and should not be considered as limiting. For example, it is contemplated that any or all of these hardware and software components may be embodied exclusively in hardware, exclusively in software, exclusively in firmware, or in any combination of hardware, software, and/or firmware. Accordingly, the disclosed embodiments may be implemented in other ways.

### II. Example Electronic Trading System

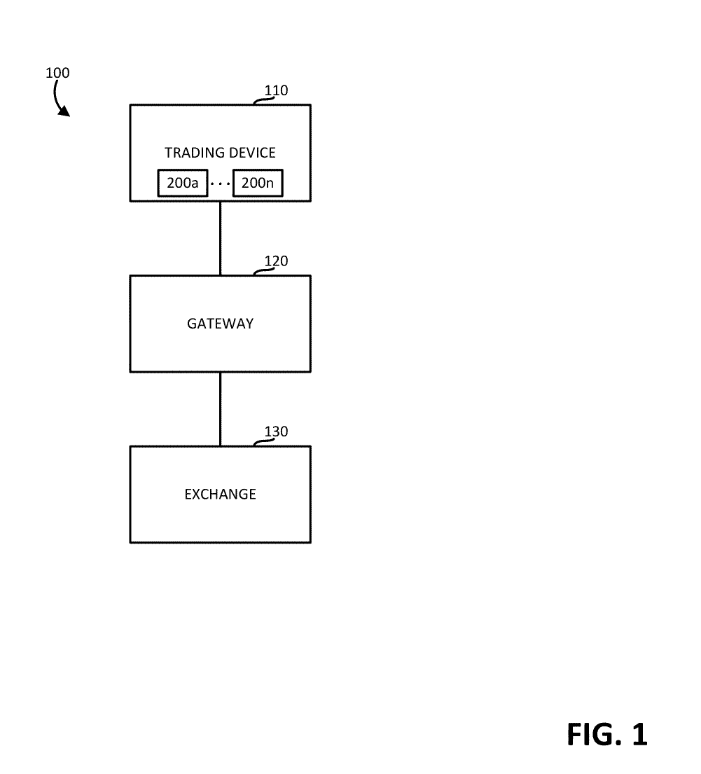

FIG. 1 illustrates a block diagram of an example electronic trading system 100 in which certain embodiments may be employed. The system 100 includes a trading device 110, a gateway 120, and an electronic exchange 130. The trading device 110 is in communication with the gateway 120. The gateway 120 is in communication with the exchange 130.

As used herein, the phrases “coupled with”, “in communication with” and “connected to” are defined to mean components arranged to directly or indirectly exchange information, data and commands through one or more intermediate components. The intermediate components may include both hardware and software based components. Moreover, the phrase “operatively coupled” is defined to mean two or more devices configured to share resources or information either directly or indirectly through one or more intermediate components.

In operation, the trading device 110 may send orders to buy or sell tradeable objects at the exchange 130. For example, a user may utilize the trading device 110 to send the orders. The orders are sent through the gateway 120 to the exchange 130. In addition, market data is sent from the exchange 130 through the gateway 120 to the trading device 110. The user may also utilize the trading device 110 to monitor this market data and/or base a decision to send an order for a tradeable object on the market data.

A tradeable object is anything which may be traded with a quantity and/or a price. For example, financial products, including stocks, options, bonds, futures, currency, warrants, funds derivatives, securities, commodities, swaps, interest rate products, index based products, traded events, goods, and collections and/or combinations of these, may be tradeable objects. A tradeable object may be “real” or “synthetic.” A real tradeable object includes products that are listed and/or administered by an exchange. A synthetic tradeable object includes products that are defined by the user. For example, a synthetic tradeable object may include a combination of real (or other synthetic) products such as a synthetic spread created by a user utilizing a trading device 110. There may be a real tradeable object that corresponds and/or is similar to a synthetic trading object.

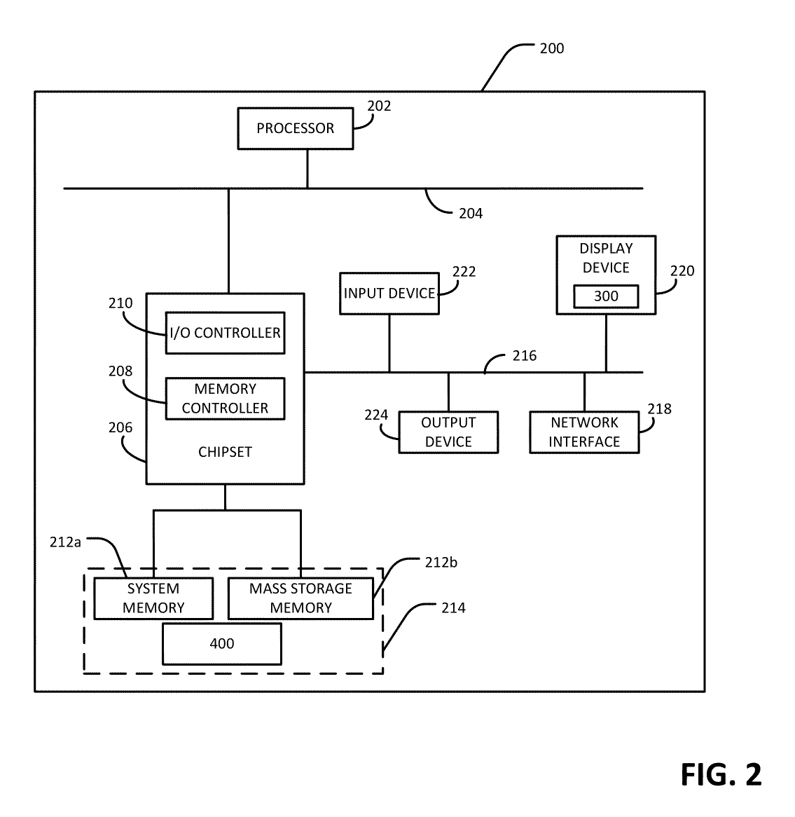

The trading device 110 may include one or more electronic computing devices 200a to 200n (see FIG. 2) such as a hand-held device, laptop, desktop computer, workstation with a single or multi-core processor, server with multiple processors, and/or cluster of computers, for example. For example, while logically represented as a single device, trading device 110 may include a trading terminal in communication with a server, where collectively the trading terminal and the server are the trading device 110. The trading terminal may provide a trading screen to a user and may communicate commands to the server for further processing of the user's inputs through the trading screen, such as placing orders.

The trading device 110 is generally owned, operated, controlled, programmed by, configured by, or otherwise used by a user. As used herein, the phrase “user” may include, but is not limited to, a human (for example, a trader) or an electronic trading device (for example, an algorithmic trading system). One or more users may be involved in the ownership, operation, control, programming, configuration, or other use, for example.

The trading device 110 may include one or more trading applications. The trading application(s) may, for example, process market data by arranging and displaying the market data in trading and charting windows. The market data may be received from exchange 130, for example. As another example, the market data may be received from a simulation environment that provides historical data and/or simulates an exchange but does not effectuate real-world trades. This processing may be based on user preferences, for example. The trading application(s) may include an automated trading tool such as an automated spread trading tool, for example. The one or more trading applications may be distributed across one or more of the computing devices of the trading device 110. For example, certain components of a trading application may be executed on a trading workstation and other components of the trading application may be executed on a server in communication with the workstation.

The trading device 110 may include an electronic trading workstation, a portable trading device, an algorithmic trading system such as a “black box” or “grey box” system, an embedded trading system, and/or an automated trading tool, for example. For example, the trading device 110 may be a computing system running a copy of X_TRADER®, an electronic trading platform provided by Trading Technologies International, Inc. of Chicago, Ill. As another example, the trading device 110 may be a computing device running an automated trading tool such as Autospreader® and/or Autotrader™, also provided by Trading Technologies International, Inc.

As another example, the trading device 110 may include a trading application which algorithmically processes market data and includes a user interface for manual placement of orders based on the algorithmic processing or to manipulate orders that were placed automatically. An algorithmic trading application is a trading application which includes an automatically processed algorithm to perform certain actions. That is, the trading application includes an automated series of instructions to perform defined action(s). The actions may include processing market data in a particular way, placing an order, modifying an existing order, deleting an order, refraining from placing an order, selecting which tradeable object(s) to act on, determining a price to place or modify an order at, determining a quantity to place an order at or modify an order to be, determining whether an order should be to buy or sell, and delaying action for a period of time, for example.

As used herein, an algorithm (also referred to as a trading algorithm) is specified by a definition which includes logic expressions and parameters that describe the algorithm to be used in trading. Logic expressions specify the relationship between parameters and may generate more parameters. Parameters may include, for example, inputs into the logic expressions of the algorithm. The definition of an algorithm may be, at least in part, specified by the algorithmic trading application. For example, an algorithmic trading application may allow a user to only specify parameters to be used by pre-defined logic expressions. As another example, an algorithmic trading application may allow a user to specify some or all of the logic expressions and some or all of the parameters. A trading algorithm where the logic expressions are specified by a user is a user-defined trading algorithm.

Trading applications may be stored in a computer readable medium of the trading device 110. In certain embodiments, one or more components of a trading application may be stored on a trading workstation and other components of the trading application may be stored on a server in communication with the workstation. In certain embodiments, one or more components of a trading application may be loaded into the computer readable medium of the trading device 110 from another computer readable medium. For example, the trading application (or updates to the trading application) may be stored by a manufacturer, developer, or publisher on one or more CDs or DVDs, which are then provided to someone responsible for loading the application onto the trading device 110 or to a server from which the trading device 110 retrieves the trading application. As another example, the trading device 110 may receive the trading application (or updates to the trading application) from a server, for example, via the Internet or an internal network. The trading device 110 may receive the trading application or updates when requested by the trading device 110 (“pull distribution”) and/or un-requested by the trading device 110 (“push distribution”).

The trading device 110 is adapted to send orders for a tradeable object. The orders may be sent in one or more messages or data packets or through a shared memory system, for example. The trading device 110 may also be adapted to cancel orders, change orders, and/or query an exchange, for example. As another example, the trading device 110 may be adapted to send orders to a simulated exchange in a simulation environment that does not effectuate real-world trades.

The orders sent by the trading device 110 may be sent at the request of a user or automatically, for example. For example, a trader may utilize an electronic trading workstation to place an order for a particular tradeable object, manually providing one or more parameters for the order, such as an order price and/or quantity. As another example, an automated trading tool may calculate one or more parameters for an order and automatically send the order. In some instances, an automated trading tool may prepare the order to be sent but not actually send it without confirmation from the user.

In certain embodiments, the trading device 110 includes a user interface. The user interface may include one or more display devices for presenting a text-based and/or graphical interface of a trading application to a user, for example. For example, the display devices may include computer monitors, hand-held device displays, projectors, and/or televisions. The user interface may be used to specify or review parameters for an order using a trading application. The user interface may include one or more input devices for receiving input, for example. For example, the input devices may include a keyboard, trackball, two or three-button mouse, and/or touch screen. The user interface may include other devices for interacting with a user. For example, information may be audibly provided to a user through a speaker and/or received through a microphone.

In certain embodiments, a trading application includes one or more trading screens to enable a user to interact with one or more markets. Trading screens may enable users to obtain and view market information, set order entry parameters, enter and cancel orders, and/or monitor and get out of positions while implementing various trading strategies, for example. For example, a trading application may receive information (such as bid prices, bid quantities, ask prices, ask quantities, prices and quantities for past sales, and/or other market related information) from exchange 130, some or all of which, in turn, may be displayed with a user interface of trading device 110. Based on the received information, the trading screen may display a range of price levels and corresponding bid and ask quantities for the price levels in regard to tradeable objects. In order to provide the user with pertinent trading information, the trading screen may display a range of prices (and the corresponding bid and ask quantities) around the inside market. The information may be continuously or regularly provided to the trading application, which allows the trading application to update the trading screen with current market information. A user may use the trading screen to place buy and sell orders for tradeable objects or to otherwise trade the tradeable objects based on the displayed information, for example.

Trading screens may display one or more trading tools. Trading tools are electronic tools that allow, assist with, and/or facilitate electronic trading. Exemplary trading tools include, but are not be limited to, charts, trading ladders, order entry tools, automated trading tools, automated spreading tools, risk management tools, order parameter tools, order entry systems, market grids, fill windows, and market order windows, combinations thereof, other electronic tools used for trading, preparing to trade, managing trades, or analyzing the market.

In certain embodiments, the orders from the trading device 110 are sent to the exchange 130 through the gateway 120. The trading device 110 may communicate with the gateway 120 using a local area network, a wide area network, a wireless network, a virtual private network, a T1 line, a T3 line, an integrated services digital network (“ISDN”) line, a point-of-presence, the Internet, and/or a shared memory system, for example.

The gateway 120 is adapted to communicate with the trading device 110 and the exchange 130. The gateway 120 facilitates communication between the trading device 110 and the exchange 130. For example, the gateway 120 may receive orders from the trading device 110 and transmit the orders to the exchange 130. As another example, the gateway 120 may receive market data from the exchange 130 and transmit the market data to the trading device 110.

In certain embodiments, the gateway 120 performs processing on data communicated between the trading device 110 and the exchange 130. For example, the gateway 120 may process an order received from the trading device 110 into a data format understood by the exchange 130. Similarly, the gateway 120 may transform market data in an exchange-specific format received from the exchange 130 into a format understood by the trading device 110. The processing of the gateway 120 may also include tracking orders from the trading device 110 and updating the status of the order based on fill confirmations received from the exchange 130, for example. As another example, the gateway 120 may coalesce market data from the exchange 130 and provide it to the trading device 110.

In certain embodiments, the gateway 120 provides services other than processing data communicated between the trading device 110 and the exchange 130. For example, the gateway 120 may provide risk processing.

The gateway 120 may include one or more electronic computing platforms such as a hand-held device, laptop, desktop computer, workstation with a single or multi-core processor, server with multiple processors, and/or cluster of computers, for example.

The gateway 120 may include one or more gateway applications. The gateway application(s) may, for example, handle order processing and market data processing. This processing may be based on user preferences, for example.

In certain embodiments, the gateway 120 communicates with the exchange 130 using a local area network, a wide area network, a virtual private network, a T1 line, a T3 line, an ISDN line, a point-of-presence, the Internet, and/or a shared memory system, for example.

In general, the exchange 130 may be owned, operated, controlled, or used by an exchange entity. Example exchange entities include the CME Group, the New York Stock Exchange/London International Financial Futures and Options Exchange (“NYSE LIFFE”), the Intercontinental Exchange (“ICE”), and Eurex. The exchange 130 may include an electronic matching system, such as a computer, server, or other computing device, that is adapted to allow tradeable objects, for example, offered for trading by the exchange, to be bought and sold. The electronic matching system may include a matching engine, for example. The exchange 130 may include separate entities, some which list and/or administer tradeable objects and others which receive and match orders, for example. The exchange 130 may include an electronic communication network (“ECN”), for example.

The exchange 130 is adapted to match orders to buy and sell tradeable objects. The tradeable objects may be listed for trading by the exchange 130. The orders may include orders received from the trading device 110, for example. Orders may be received from the trading device 110 through the gateway 120, for example. In addition, the orders may be received from other devices in communication with the exchange 130. That is, typically the exchange 130 will be in communication with a variety of other trading devices (which may be similar to trading device 110) that also provide orders to be matched.

The exchange 130 is adapted to provide market data. The market data may be provided in one or more messages or data packets or through a shared memory system, for example. The market data may be provided to the trading device 110, for example. The market data may be provided to the trading device 110 through the gateway 120, for example. The market data may include data that represents the inside market, for example. The inside market is the lowest sell price (also referred to as the “best ask”) and the highest buy price (also referred to as the “best bid”) at a particular point in time (since the inside market may vary over time). The market data may also include market depth. Market depth refers to the quantities available at the inside market and may also refer to quantities available at other prices away from the inside market. Thus, the inside market may be considered the first level of market depth. One tick away from the inside market may be considered the second level of market depth, for example. In certain embodiments, market depth is provided for all price levels. In certain embodiments, market depth is provided for less than all price levels. For example, market depth may be provided only for the first five price levels on both sides of the inside market. As another example, market depth may be provided for the first ten price levels at which quantity is available in the market. The market data may also include information such as the last traded price (LTP), the last traded quantity (LTQ), and order/fill information.

In certain embodiments, the system 100 includes more than one trading device 110. For example, multiple trading devices similar to the trading device 110, discussed above, may be in communication with the gateway 120 to send orders to the exchange 130.

In certain embodiments, the system 100 includes more than one gateway 120. For example, multiple gateways similar to the gateway 120, discussed above, may be in communication with the trading device 110 and the exchange 130. Such an arrangement may be used to provide redundancy should one gateway 120 fail, for example.

In certain embodiments, the system 100 includes more than one exchange 130. For example, the gateway 120 may be in communication with multiple exchanges similar to the exchange 130, discussed above. Such an arrangement may allow the trading device 110 to trade at more than one exchange through the gateway 120, for example.

In certain embodiments, the system 100 includes more than one exchange 130 and more than one gateway 120. For example, multiple gateways similar to the gateway 120, discussed above, may be in communication with multiple exchanges similar to the exchange 130, discussed above. Each gateway may be in communication with one or more different exchanges, for example. Such an arrangement may allow one or more trading devices 110 to trade at more than one exchange (and/or provide redundant connections to multiple exchanges), for example.

In certain embodiments, the trading device 110 includes one or more computing devices or processing components. In other words, the functionality of the trading device 110 may be performed by more than one computing device. For example, one computing device may generate orders to be sent to the exchange 130 while another computing device may provide a graphical user interface to a user. In certain embodiments, the gateway 120 includes one or more computing devices or processing components. In other words, the functionality of the gateway 120 may be performed by more than one computing device. In certain embodiments, the exchange 130 includes one or more computing devices or processing components. In other words, the functionality of the exchange 130 may be performed by more than one computing device.

In certain embodiments, the gateway 120 is part of the trading device 110. For example, the components of the gateway 120 may be part of the same computing platform as the trading device 110. As another example, the functionality of the gateway 120 may be performed by components of the trading device 110. In certain embodiments, the gateway 120 is not present. Such an arrangement may occur when the trading device 110 does not need to utilize the gateway 120 to communicate with the exchange 130, for example. For example, if the trading device 110 has been adapted to communicate directly with the exchange 130.

In certain embodiments, the gateway 120 is physically located at the same site as the trading device 110. In certain embodiments, the gateway 120 is physically located at the same site as the exchange 130. In certain embodiments, the trading device 110 is physically located at the same site as the exchange 130. In certain embodiments, the gateway 120 is physically located at a site separate from both the trading device 110 and the exchange 130.

In certain embodiments, the system 100 may include other devices that are specific to the communications architecture such as middleware, firewalls, hubs, switches, routers, exchange-specific communication equipment, modems, security managers, and/or encryption/decryption devices.

### III. Example Computing Device

FIG. 2 illustrates a block diagram representing one of the electronic computing devices 200a to 200n (generally referred to hereinafter as the electronic computing device 200) that may be used to implement the disclosed embodiments. The trading device 110 of FIG. 1 may include one or more computing devices 200, for example. The gateway 120 of FIG. 1 may include one or more computing devices 200, for example. The exchange 130 of FIG. 1 may include one or more computing devices 200, for example.

The exemplary computing device 200 includes a processor 202, an interconnection bus 204, a chipset 206, a memory controller 208, an input/out (I/O) controller 210, a system memory 212a and a mass storage memory 212b (collectively identified as memory 214), an I/O bus 216, a network interface 218, a display 220, an input device 222, and an output device 224. The exemplary computing device 200 may include additional, different, or fewer components. For example, multiple buses, multiple processors, multiple memory devices, multiple network interfaces, multiple display devices, multiple input devices, multiple output devices, or any combination thereof, may be provided. As another example, the computing device 200 may not include an output device 224 separate from the display device 220. As another example, the computing device 200 may not include a display device 220. As another example, the computing device 200 may not include an input device 222. Instead, for example, the computing device 200 may be controlled by an external or remote input device via the network interface 218.

The computing device 200 includes a processor 202 coupled to an interconnection bus 204. The interconnection bus 204 may include a communication bus, channel, network, circuit, switch, fabric, or other mechanism for communicating data between components in the computing device 200. The interconnection bus 204 may be communicatively coupled with and transfer data between any of the components of the computing device 200. For example, during an installation process of a trading application, one or more computer-readable instructions that are to be executed by the processor 202 may be transferred from the input device 222 and/or the network interface 218 to the system memory 212a and/or the mass storage memory 212b. When the computing device 200 is running or preparing to run the trading application stored in the system memory 212a and/or the mass storage memory 212b, the processor 202 may retrieve the instructions from the system memory 212a and/or the mass storage memory 212b via the interconnection bus 204.

The processor 202 may be a processor, processing unit, or microprocessor, for example. The processor 202 may include one or more general processors, digital signal processors, application specific integrated circuits, field programmable gate arrays, analog circuits, digital circuits, programmed processors, and/or combinations thereof, for example. The processor 202 may be a single device or a combination of devices, such as one or more devices associated with a network or distributed processing. Any processing strategy may be used, such as multi-processing, multi-tasking, parallel processing, and/or remote processing. Processing may be local or remote and may be moved from one processor to another processor. The computing device 200 may be a multi-processor system and, thus, may include one or more additional processors that are communicatively coupled to the interconnection bus 204.

The processor 202 may be operable to execute logic encoded in one or more tangible media, such as the system memory 212a, the mass storage memory 212b, and/or via the network interface 218. As used herein, logic encoded in one or more tangible media includes instructions that are executable by the processor 202 or a different processor. The logic may be stored as part of software, hardware, integrated circuits, firmware, and/or micro-code, for example. The logic may be received from an external communication device via a communication network, for example, connected to the Internet. The processor 202 may execute the logic to perform the functions, acts, or tasks illustrated in the figures or described herein.

The processor 202 of FIG. 2 is coupled to the chipset 206, which includes the memory controller 208 and the I/O controller 210. A chipset typically provides I/O and memory management functions as well as a plurality of general purpose and/or special purpose registers and timers that are accessible or used by one or more processors coupled to the chipset 206. The memory controller 208 performs functions that enable the processor 202 (or processors if there are multiple processors) to access the system memory 212a and the mass storage memory 212b.

The system memory 212a and the mass storage memory 212b may be one or more tangible media, such as computer readable storage media, for example. The system memory 212a may include various types of volatile and non-volatile storage media, including, for example, random access memory (RAM), read-only memory (ROM), programmable read-only memory (PROM), electrically programmable read-only memory (EPROM), electrically erasable read-only memory (EEPROM), flash memory, any other tangible data storage device, any combination thereof. The mass storage memory 212b may include various types of mass storage devices including, for example, a hard disk drive, optical media, magnetic tape, any other tangible data storage device, or any combination thereof. In certain embodiments, the system memory 212a and the mass storage memory 212b are non-transitory.

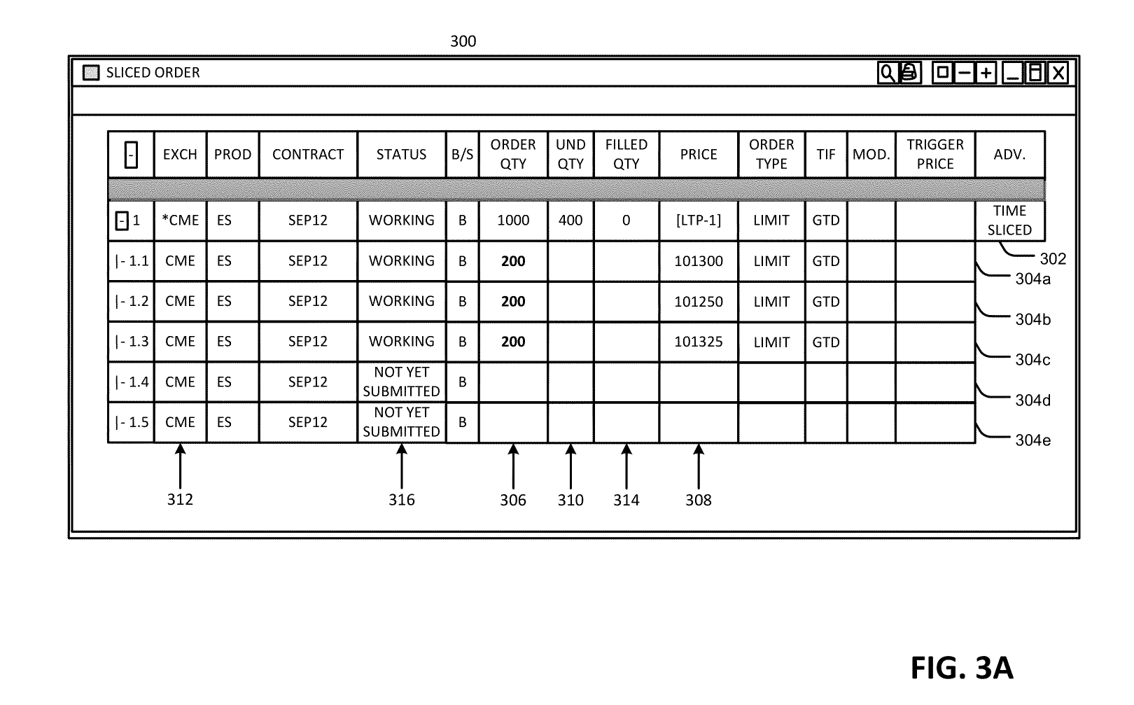

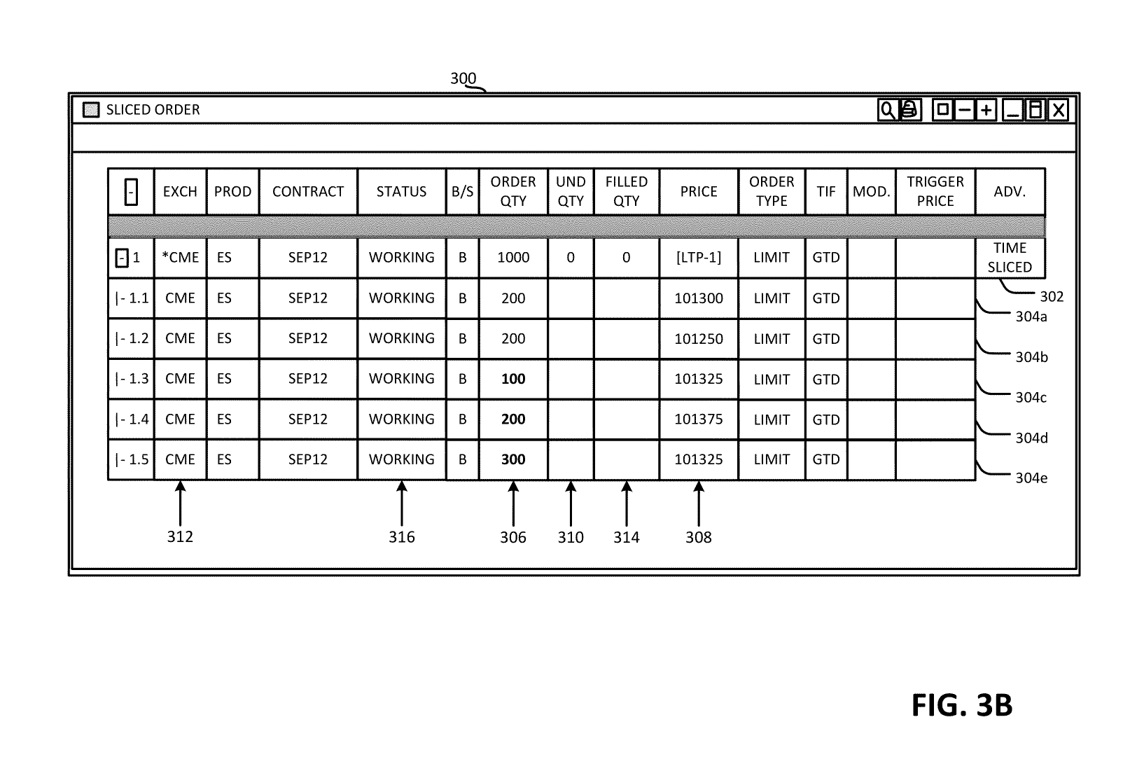

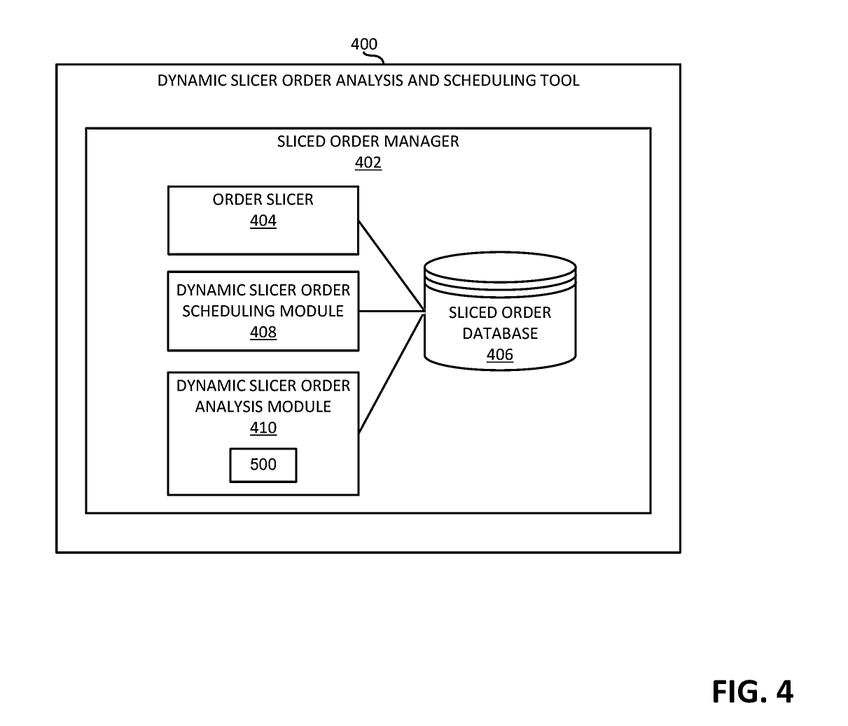

The system memory 212a and the mass storage memory 212b may be a single memory module, for example. The system memory 212a and the mass storage memory 212b may be adjacent to, part of, programmed with, networked with, and/or remote from processor 202, such that data stored in the system memory 212a and the mass storage memory 212b may be retrieved and processed by the processor 202, for example. The system memory 212a and the mass storage memory 212b may store instructions that are executable by the processor 202. The instructions may be executed to perform one or more of the acts or functions described herein or shown in the figures. It will be understood that the system memory 212a and the mass storage memory 212b portion of the memory 214 may store the processor executable instructions and code configured to generate a graphical user interface (GUI) 300 (see FIGS. 3A and 3B). The GUI 300 stored and accessible in the memory 214 may be configured to control and display information exchanged with the dynamic slicer order analysis and scheduling tool 400 (shown in FIG. 4).

The I/O controller 210 performs functions that enable the processor 202 to communicate with the network interface 218, the display 220, the input device 222, and the output device 224 through an I/O bus 216. While the memory controller 208 and the I/O controller 210 are depicted in FIG. 2 as separate blocks within the chipset 206, the functions performed by these blocks may be integrated within a single semiconductor circuit or may be implemented using two or more separate integrated circuits. One or more of the components of the computing device 200 may be implemented as a system on a chip (for example, a system on a chip in an IPHONE™).

The network interface 218 may be a one-way or two-way communication coupling. Accordingly, the network interface 218 may communicatively connect one, two, or more communication networks or devices. For example, the interconnection bus 204 may be coupled with a gateway similar to gateway 120 of FIG. 1 discussed above via the network interface 218, such that one, some, or all of the components of the computing device 200 are accessible or may communicate with the gateway. As another example, the network interface 218 may couple the interconnection bus 204 with other communication networks. The network interface 218 may be, for example, an integrated services digital network (ISDN) card or a modem to provide a data communication connection. As another example, network interface 218 may be a local area network (LAN) card to provide a data communication connection to a compatible LAN, for example, connected to the Internet. Wireless links may also be implemented. The network interface 218 may send and receive electrical, electromagnetic, or optical signals that carry analog or digital data streams representing various type of information, for example.

The display device 220 may include a visual output device, cathode ray tube (CRT) display, electronic display, electronic paper, flat panel display, light-emitting diode (LED) display, electroluminescent display (ELD), plasma display panel (PDP), liquid crystal display (LCD), thin-film transistor display (TFT), organic light-emitting diode display (OLED), surface-conduction electron-emitter display (SED), laser television, carbon nanotubes, nanocrystal display, head-mounted display, projector, three-dimensional display, and/or transparent display device, for example.

The display device 220 is adapted to display a trading screen such as, for example, the GUI 300. The exemplary trading screen may be similar to the trading screens discussed above, for example. The trading screen may be interactive. An interactive trading screen may allow, for example, one or more trading actions to be performed using the trading screen. For example, an interactive trading screen may allow one or more order entry parameters to be set and/or sent using one or more order entry actions. The display device 220 and/or the input device 222 may be used to interact with the trading screen, for example.

The input device 222 may include a keyboard, mouse, microphone, touch-screen, trackball, keypad, joystick, and/or other device for providing input, for example. The input device 222 may be used, for example, to provide command selections to processor 202. For example, the input device 222 may be a mouse that is used to control a cursor displayed on a trading screen. The mouse may include one or more buttons for selection and control, for example.

The output device 224 may include a keyboard, mouse, speakers, touch-screen, trackball, keypad, haptic device or system, joystick, and/or other device for providing output, for example. For example, the output device 224 may be used to output one or more signals, such as a haptic signal or an audio signal, to a user. While the input device 222 and output device 224 are depicted in FIG. 2 as separate blocks, the functions performed by these blocks may be integrated into a single I/O device.

### IV. Slicer Orders

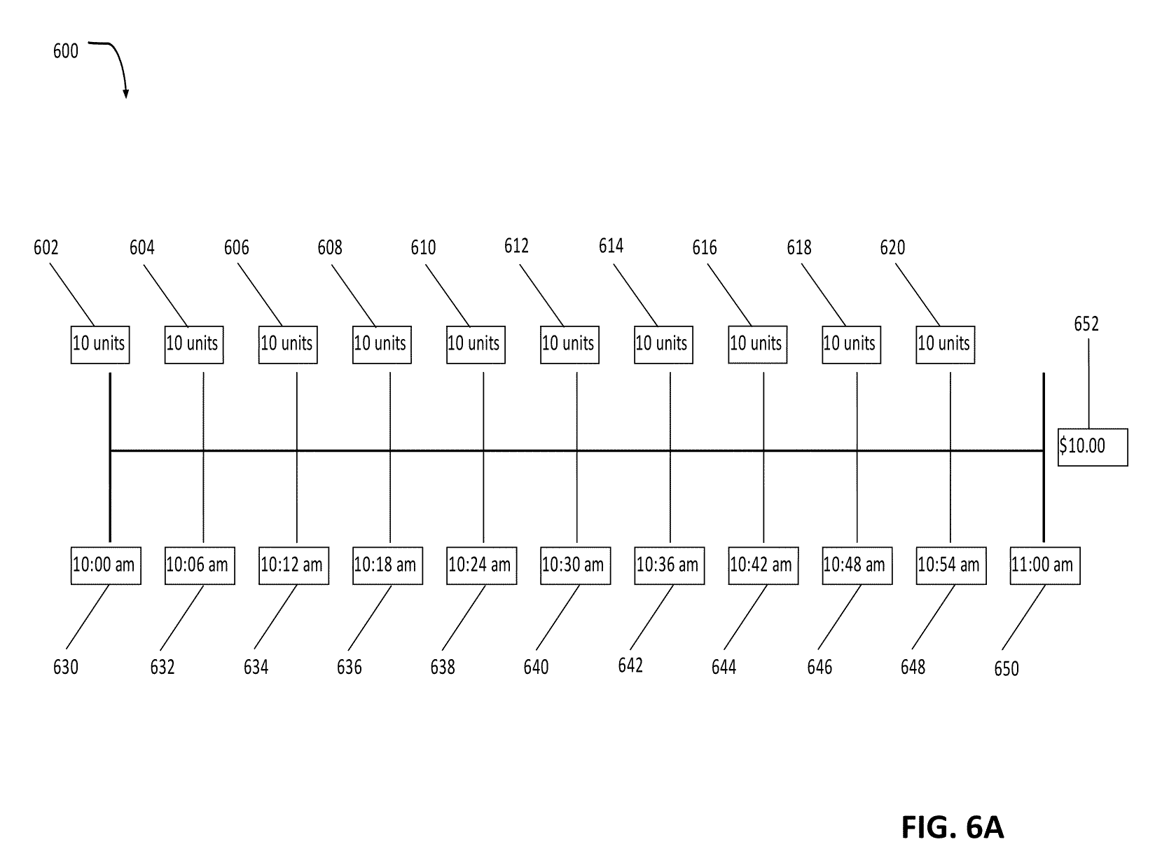

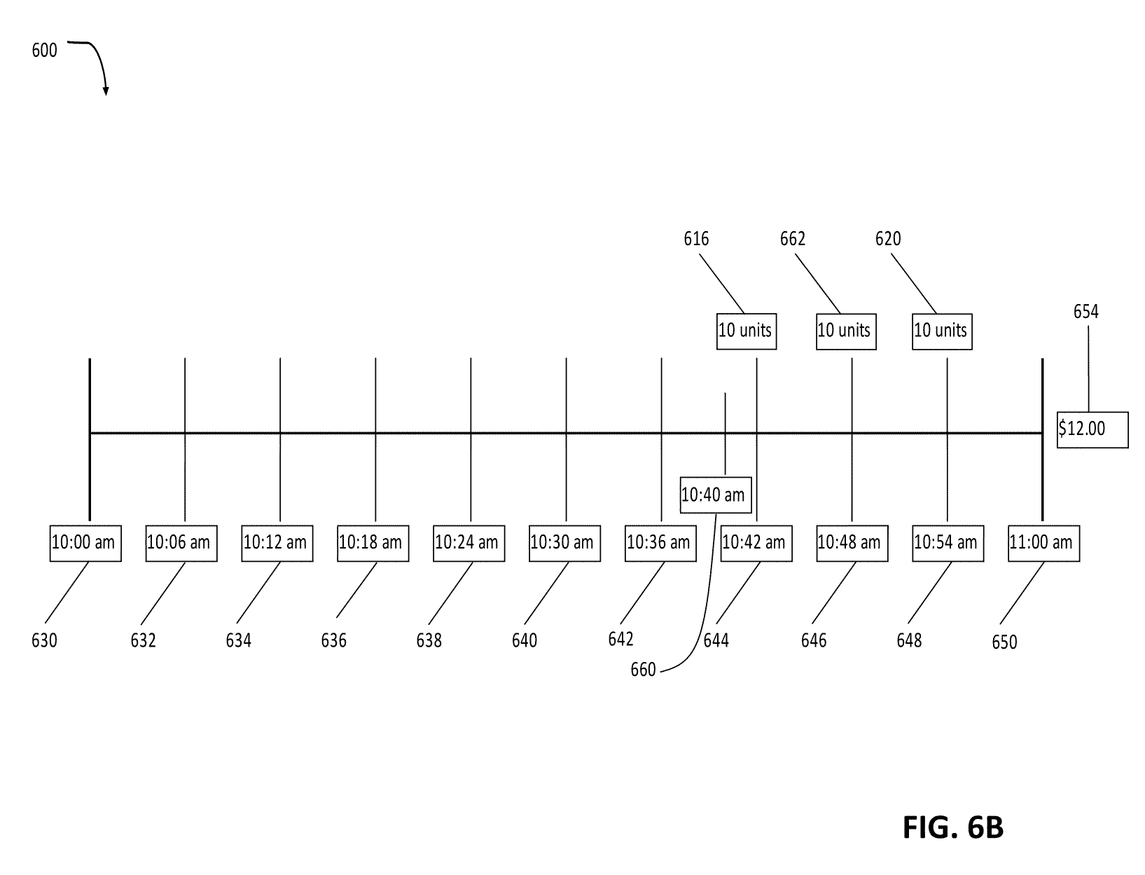

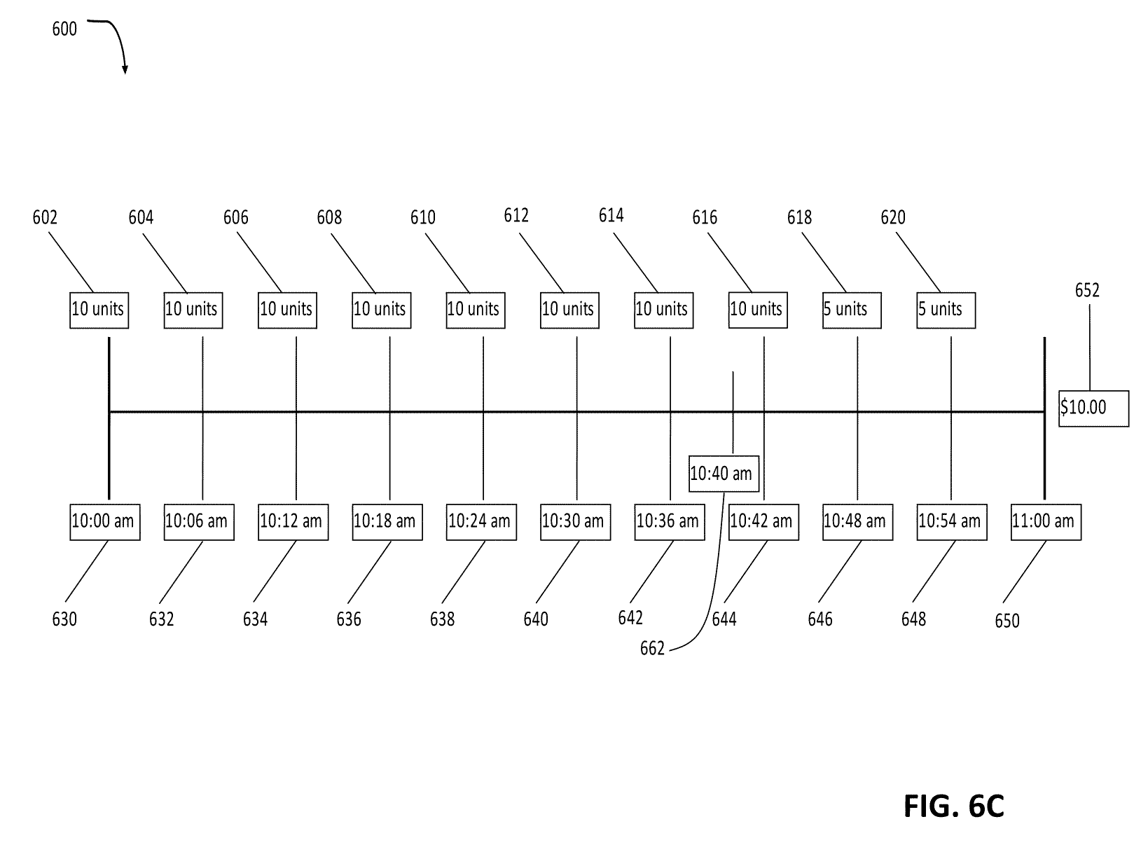

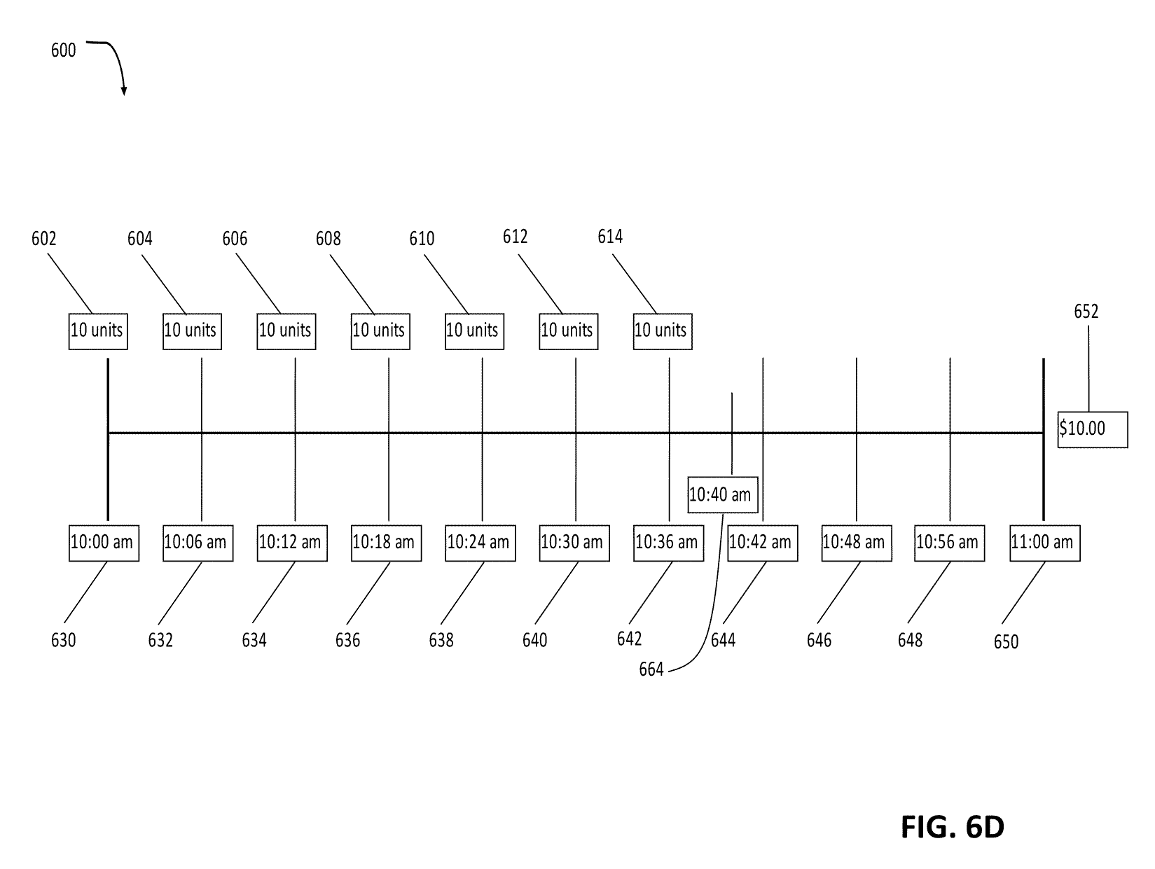

Slicer orders have component parts (referred to herein as child orders) that are separately sent to one or more markets to collectively buy or sell a total quantity of a tradeable object. To implement a slicer order, a trading device sends at least one of the child orders to one or more markets in response to, for example, an event or condition defined in the slicer order, such as an amount of time elapsing or a volume of activity occurring at the market(s). FIG. 6A generally illustrates one example of a slicer order that may be implemented in connection with one or more of the embodiments disclosed herein. In particular, FIG. 6A depicts a slicer order 600 comprising one hundred units (100) at an order price 652 equal to ten dollars ($10) per unit. The one hundred units are evenly distributed between ten (10) child orders individually identified as orders 602 to 620. After an initiation or activation of the slicer order, the trading device automatically sends the child orders, when triggered, to the market(s) to collectively buy or sell the total quantity of the parent order. For example, as shown in FIG. 6A each of the ten (10) child orders 602 to 620 is sent to the market according to a schedule that places one of the child orders 602 to 620 containing ten (10) units into the market at six (6) minute intervals indicated by the reference numerals 630 to 648. In addition to or in lieu of automatically sending child orders to the markets in response to triggers or detected events, the trading device can send child orders in response to direct user input. In other words, the user can instruct the trading device to send a child order and the trading device assists the user by, for example, tracking fill quantity and prices, insuring a sum of the child quantities does not exceed the parent quantity, processing delete and quantity change requests, etc.

FIG. 3A depicts the GUI 300 at a first point in time configured to communicate and display slicer order information to a user of the trading device 110 shown in FIG. 1. The exemplary GUI 300 shown in FIG. 3A displays a parent order 302 having a plurality of child orders 304a to 304c (generally identified as child orders 304). Each of the child orders 304 has a designated quantity, which is shown in a quantity column 306, and a price, which is shown in a price column 308. The order quantities of the child orders 304 add up to the total quantity of the parent order 302. The exemplary GUI 300 includes an undisclosed quantity column 310 to indicate a quantity of the slicer order that has not yet been sent to market. As shown in FIG. 3A, the slicer order plan and schedule includes three (3) child orders 304a to 304c each having a quantity of two hundred (200) being sent to a market according to a specific time interval. As a result of these scheduled submissions, the undisclosed quantity of the slicer order indicates that a quantity of four hundred (400) remains to be submitted. The slicer order plan and schedule includes two (2) additional child orders 304d and 304e scheduled but not-yet submitted into the market. In the absence of a user-requested modification, the additional child orders 304d and 304e would be submitted into the market such that each had a quantity of two hundred (200) which is equal to the undisclosed quantity. The illustrated exemplary slicer order is a time slicer order in which each of the child orders 304 has been sent to one or more markets defined in an exchange column 312 when a defined time interval elapsed and/or when a time and date occurred. As the child orders 304 are sent to market and are filled, a filled quantity column 314 is updated to indicate how much of the respective child order quantities and the parent order quantity is filled. Additionally, as the child orders 304 are sent to market(s), a status column 316 is updated to indicate a current status of the child orders. Additional or alternative information not described herein and may be incorporated into and/or displayed by the GUI 300 in order to facilitate understanding of and interaction with the parent and child orders 302 and 304, respectively that comprise the exemplary slicer order.

As markets and other factors are constantly changing, a user associated with the slicer order may wish to adjust one or more aspects of the parent or child order portions of the slicer order after the slicer order is working in a market. For example, the user may wish to modify the total quantity of the parent order or the quantity of a specific child order after at least one of the child orders has been sent to the market(s). However, satisfying a desired change request may be difficult to accomplish while satisfying one or more of the user-defined and/or slicer parameters governing the configuration of the slicer order. For example, one or more of the child orders may have already been filled by the time the desired quantity modification is conveyed to a trading device (for example, via the GUI 300) implementing the slicer order. Additionally or alternatively, one or more of the child orders may be inflight when the desired quantity reduction is conveyed to the trading device. An inflight child order is one for which the trading device has not yet received a confirmation message in response to a message, query, or other type of communication regarding the order that was sent to, for example, an exchange. In other words, an inflight child order is one that has an outstanding communication, the results of which are unknown to the trading device. For example, the trading device may have sent an order for a tradable object at a certain price but has not yet been informed as to whether or not the order has been accepted by the exchange.

FIG. 3B depicts the exemplary GUI 300 at a second point in time, after the first point in time of FIG. 3A. In this instance, the user may have requested a change in the working child order 304c. The user-requested modification or change may reduce the quantity of the working child order 304c from the original two hundred (200) to a new quantity of one hundred (100). This user-requested change requires that the original slicer order plan and schedule be updated to compensate. In order to compensate and address the exemplary user-requested change, the exemplary dynamic slicer order analysis and scheduling tool 400 may recompute and replan the slicer order plan. For example, the dynamic slicer order analysis and scheduling tool 400 may generate a new and/or revised slicer plan that directs the submission of a subsequent child order 304d with an original quantity of two hundred (200), and increases the quantity of a child order 304e to three hundred (300). Alternatively, the dynamic slicer order analysis and scheduling tool 400 may adjust the quantities of both child orders 304d and 304e to two hundred and fifty (250). In yet another alternative, the dynamic slicer order analysis and scheduling tool 400 may maintain child orders 304d and 304e at the original quantity of two hundred (200) and place a new child order 304f (not shown) having a quantity of one hundred (100). These changes in the slicer plan insure that the sum of each individual child order 304 listed in column 306 equal the total order quantity of the parent order 302 (i.e., one thousand) listed in column 306. The dynamic slicer order analysis and scheduling tool 400 may be utilized to address a wide variety of user-requested changes and alterations as will be discussed in greater detailed herein.

Unlike previous systems, embodiments disclosed herein provide a mechanism for dynamically adjusting the operation and configuration of an executing or operational slicer order as requested by a user without having to cancel and resubmit the slicer order from the beginning

### V. Dynamic Slicer Order Analysis and Scheduling Tool

FIG. 4 is a block diagram of the exemplary dynamic slicer order analysis and scheduling tool 400 discussed and described herein. The exemplary dynamic slicer order analysis and scheduling tool or dynamic slicer tool 400 includes and cooperates with a slicer order manager 402. The slicer order manager 402, in turn, includes an order slicer 404 to break down a parent order into one or more child orders in accordance with, for example, locked parameters and/or other slicer order parameters established by the user. For example, the order slicer 404 may be configured with user instructions, user defined and/or locked parameters and other values regarding the quantities, intervals, triggers, prices, etc. necessary to implement the breakdown of the parent order 302. The order slicer 404 may be configured to accessibly store the user instructions and/or user defined or locked parameters locally or in an exemplary slicer order database 406. The slicer order database 406 may be configured to store and organize the slicer order data in any suitable manner such that the information may be retrieved and utilized in operation by the dynamic slicer order analysis and scheduling tool 400.

The exemplary slicer order manager 402 may further cooperate with an exemplary dynamic slicer order scheduling module 408 and a dynamic slicer order analysis module 410. In operation, the slicer order manager 402 may direct the order slicer 404 to cooperate with the dynamic slicer order scheduling module 408 to generate a slicer plan that governs the submission of individual child orders 304 into the market. In particular, the slice order manager 402 utilizes user provided parameters and information stored in the sliced order database 406 to generate a plan for slicing and segmenting a parent order 302. As previously discussed, FIG. 3A illustrates the GUI 300 showing the submission of child orders 304a to 304c into the market specified in exchange column 312. Upon receipt of a user request to change the quantity of child order 304c from two hundred (200) to one hundred (100) as shown in FIG. 3B, the slicer order manager 402 may direct the order slicer 404 and the dynamic slicer order analysis module 410 to activate. Upon activation, the order slicer 404 and the dynamic slicer order analysis module 410 may evaluate the user-requested change as a function of the user defined information and parameters stored in the sliced order database 406.

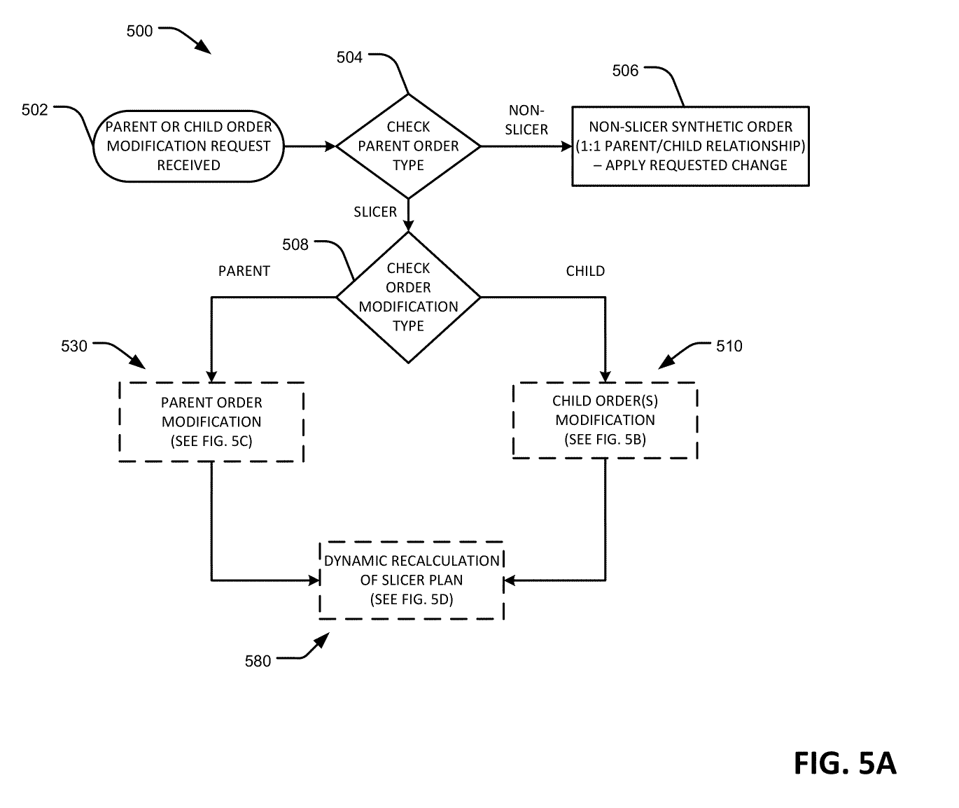

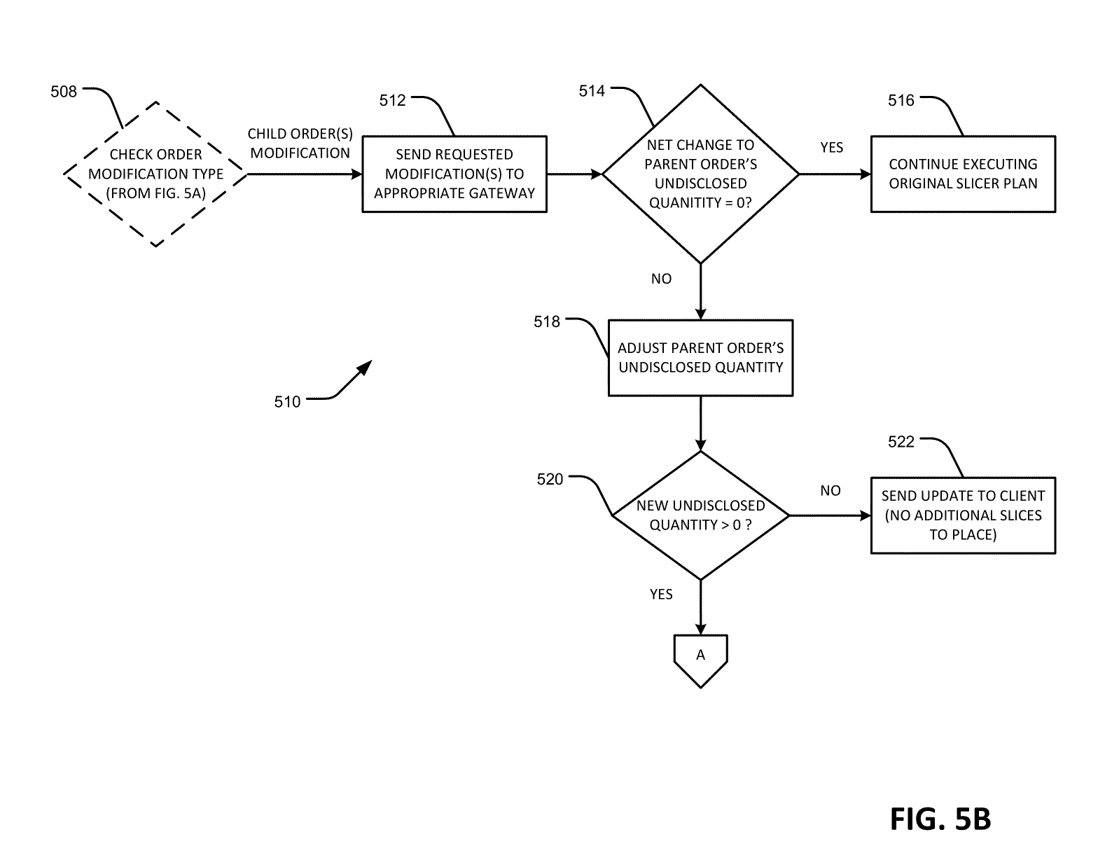

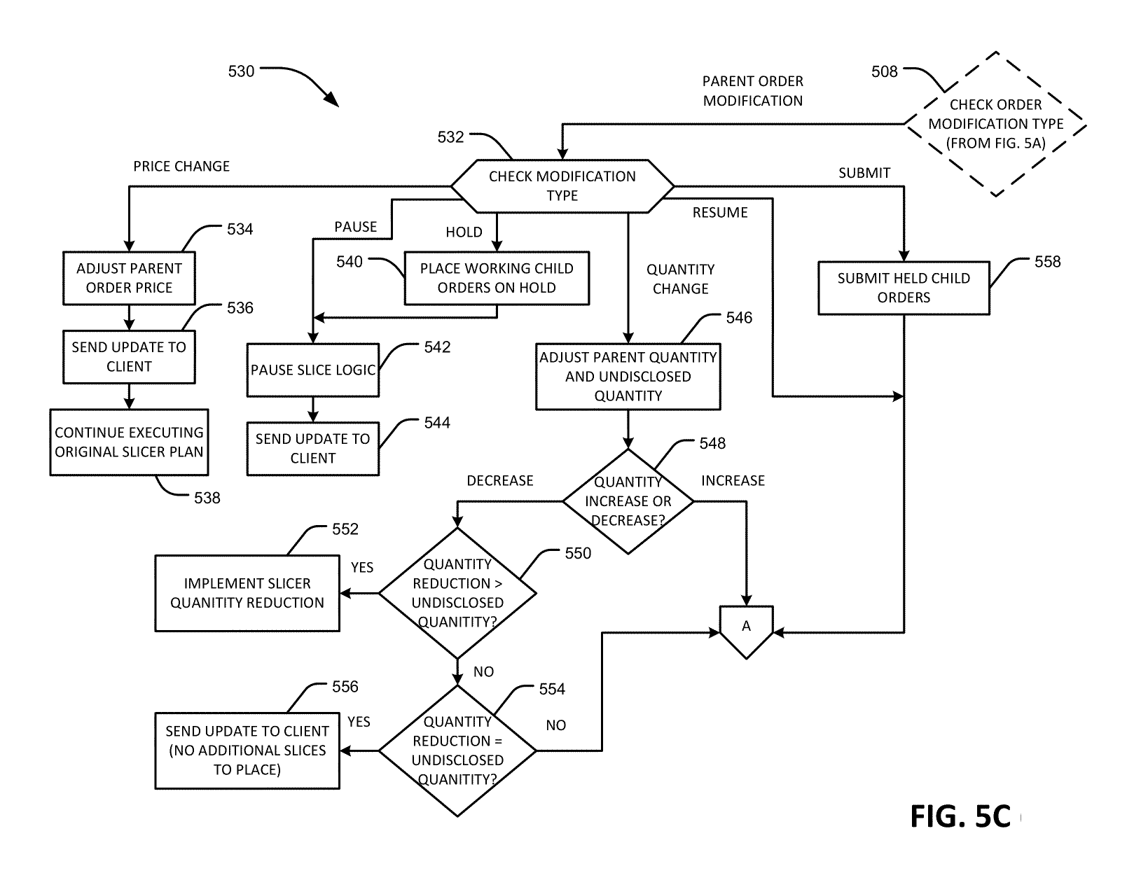

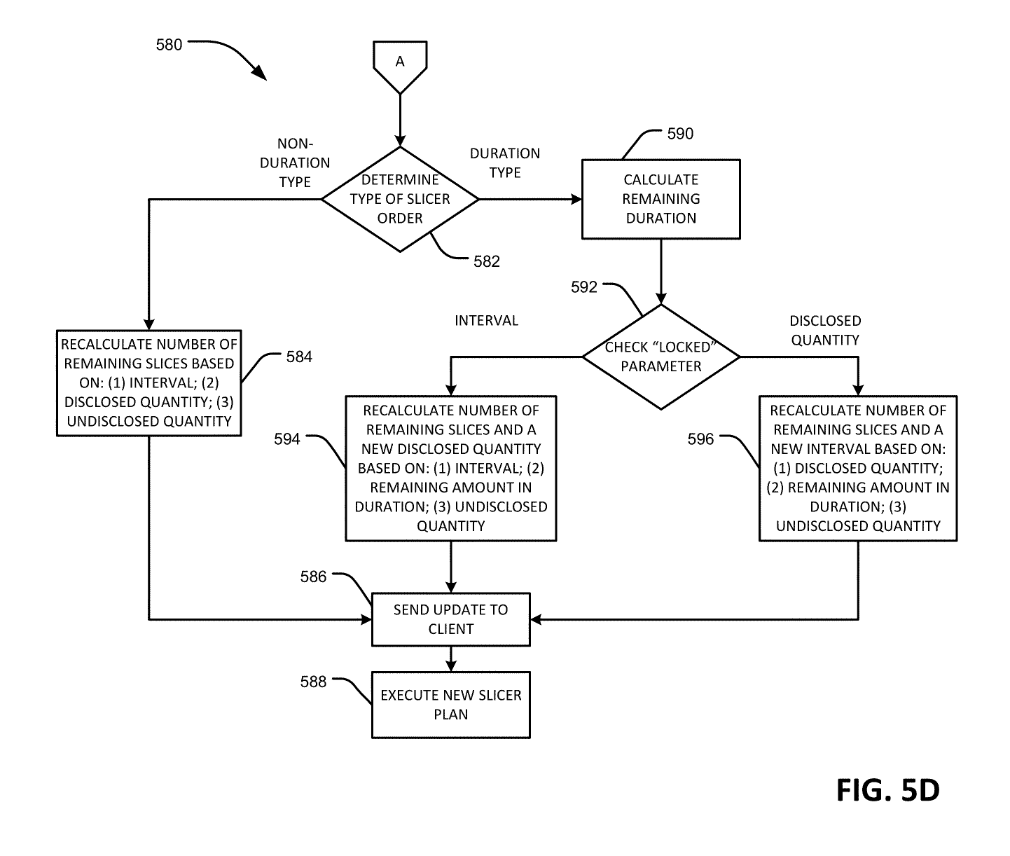

The evaluation of the user-requested change may be conducted according to the exemplary control routine 500 depicted and discussed in connection with the flowcharts shown in FIGS. 5A to 5D. The results generated by the exemplary control routine 500 may, in turn, be utilized by the order slicer 404 and the dynamic order scheduling module 408 to replan the original slicer plan. By allowing users to replan an executing slicer order, the exemplary slicer order manager 402 provides a mechanism by which changing market conditions, customer requirements and other market information can, in real time or near real time, be factored into a trading strategy.

FIGS. 5A to 5D illustrate an exemplary control routine 500 that may be implemented to provide dynamic control over an executing trading strategy such as a slicer order. At block 502, the dynamic slicer order analysis and scheduling tool 400 and more particularly the dynamic slicer order analysis module 410 begins implementation of the control routine 500 when a user modification request is received. For example, a user may change one or more of the values displayed in the GUI 300 thereby causing the dynamic slicer order analysis and scheduling tool 400 to initiate a recalculation of the slicer plan to accommodate and incorporate the desired change(s). At block 504, the control routine 500 as implemented by the tool 400 evaluates the parent order 302 to determine if it is a slicer order or a non-slicer order. Examples of non-slicer orders include triggered orders such as Stop or If Touched orders, and timed orders such as limit orders with a user specified end time and end time action. If the control routine 500 determines that the user-requested modification is directed to a non-slicer order, then at block 506 the desired modification and changes are applied. Because the parent and child orders of a non-slicer order are defined to have a one-to-one relationship, any desired change to one of the order results in an equivalent change in the other order. Stated another away, if the user-requested modification calls for a quantity change of ten (10) in the parent order, the corresponding child order is likewise changed by a quantity of ten (10). However, if the tool 400 determines at block 504 that the user-requested modification is directed to a slicer order, the control routine 500 proceeds to block 508.

At block 508, the control routine 500 as implemented by the tool 400 evaluates the user-requested modification to determine if it is directed to a parent order 302 or a child order 304. If the user-requested modification is directed to a parent order 302, the control routine 500 proceeds to the parent order modification subroutine indicated by the reference numeral 530. However, if the user-requested modification is directed to one or more child orders 304, the control routine 500 proceeds to the child order modification subroutine indicated by the reference numeral 510. Upon completion of either the parent order modification subroutine 530 or the child order modification subroutine 510, the control routine 500 activates and implements a dynamic slicer plan recalculation subroutine 580 to revise and replan the slicer order plan controlling or directing the slicer order currently executing in the market.

At block 510, the control routine 500 implements the exemplary child order modification subroutine shown in FIG. 5B. Referring to block 512 shown in FIG. 5B, the exemplary control routine 500 as implemented by the tool 400 communicates and/or transmits the user-requested modification from one of the trading devices 110 to the appropriate gateway 120. In particular, the user-requested modification is communicated to the appropriate gateway 120 at which the child order(s) resides. The gateway 120 may, in one or more embodiments, be the gateway physically located closest to the market and/or exchange identified in exchange column 312. In another configuration, the user-requested modification may be communicated from one of the trading devices 110 directly to the exchange 130.

At block 514, the control routine 500 evaluates the effect of the user-requested modification on the undisclosed quantity associated with the parent order 302. For example, the control routine 500 may determine if the user-requested modification affects the value listed in the undisclosed quantity column 310 shown in FIG. 3A. If the user-requested modification results in no net change to the undisclosed quantity listed in column 310, then at block 516 the control routine 500 continues to execute and implement the original slicer plan specified by the order slicer 404 in accordance with one or more of the user defined parameters stored in the slicer order database 406. Alternatively, if the user-requested modification results in either an increase or a decrease in the undisclosed quantity listed in column 310, then the control routine 500 proceeds to block 518.

At block 518, the control routine 500 adjusts and updates the undisclosed quantity (see, for example, column 310 of FIG. 3A) associated with the parent order 302 based on the user specified quantity increase or decrease. If, at block 520, the control routine 500 determines that the updated undisclosed quantity equals zero (i.e., if all of the order quantity of the parent order 302 has been sent to the market), then the control routine 500 communicates an update to the trading device 110 and more specifically to the GUI 300 displayed for the user via the display device 220. However, should the control routine 500 determine that an undisclosed quantity or orders remain to be placed in the market (i.e., there exists one or more child orders 304 to be placed in the market), then at block 520 the control routine proceeds to the dynamic slicer plan recalculation subroutine 580 (see FIG. 5D).

Returning to block 508 (FIG. 5A), if the control routine 500 as implemented by the tool 400 evaluates the requested user modification and determines it is directed to a parent order 302, then the parent order modification subroutine 530 is initiated. Upon receipt of the requested user modification, the parent order modification subroutine 530 evaluates the user request to determine the type of modification to be implemented (see FIG, 5C). The requested user modification could be a command or request to: (1) implement a price change associated with the parent order; (2) pause the operation of the slicer order, (3) place a hold on the slicer order and the child orders currently working in the market; (4) resume execution of a paused slicer order; (5) submit a held slicer order, or (6) implement a quantity change associated with the parent order. Should the user-requested modification specify both a price change and a quantity change, the control routine 500 addresses this contingency by implementing the quantity change associated with the parent order (see block 546) as if it included price change functionality (see block 534). Depending upon the type of modification or change requested by the user, the control routine 500 implements corresponding slicer logic as illustrated in the example shown in FIG. 5C.

If the control routine 500 determines that the user-requested modification is a price change, then the parent order modification subroutine 530 proceeds to block 534 and causes the price of the parent order 302 to be adjusted while leaving the quantities and timing associated with the child orders unchanged. Subsequently, as indicated at block 536, an update reflecting the adjusted price may be provided to the user for review and/or confirmation via the GUI 300. Upon completion of the price update, the control routine at block 538 continues to implement the order quantities and timing specified in the original slicer plan established by the order slicer 404 in connection with the user defined parameters stored in the sliced order database 406. Thus, new child orders will be placed based on the original quantity and timing of the splicer plan and at the newly specified price.

For example, FIG. 6B depicts a parent order modification request 660 implemented in connection with the slicer order 600 shown in FIG. 6A. In particular, the parent order modification request 660 is issued at time 10:40 AM in order to modify the slicer order price 652 of ten dollars ($10) per unit (see FIG. 6A) to reflect an updated slicer order price 654 of twelve dollars ($12) per unit. In response to the parent order modification request 660 received at 10:40AM, the remaining unexecuted child orders 616 to 620 will be executed according to the scheduled times 644 to 648 originally established but at the modified slicer order price 654 of twelve dollars ($12) per unit.

In yet another example, the control routine 500 may monitor the average fill price of the parent order. Upon determining that the average fill price has become worse than the limit price, where it is above the limit price for buy orders or below the limit price for sell orders, the control routine 500 issues a price change order modification request to update the slicer order plan. At block 534, the control routine 500 determines an adjusted price for pending child orders at which the average fill price will be improved. At block 538, the control routine 500 will execute the modified slicer order plan according to the adjusted price. If the average fill price continues to fluctuate, the control routine 500 may continue to adjust the price of pending child orders.

Alternatively, the control routine 500 may determine that the user-requested modification is intended to pause or hold the operating slicer order. If the user-requested modification is a hold command, the control routine 500 at block 540 places a hold on each of the child orders 304 working in the market. The hold requests that the gateway 120 or the exchange 130 remove the order from the market, thereby preventing the order from being filled. Upon complete implementation of the hold command, the control routine 500 proceeds to block 542 and executes pre-defined pause logic which halts all active slicer order activities including placing new child orders 304. At block 544, the user may be provided with an update confirming the cessation of slicer order activity. Similarly, if the user-requested modification is a pause command, then at block 542 the control routine 500 halts all further slicer order activity as part of the pre-defined pause logic. The pause logic stops the execution of the slicer order activity while allowing child orders 304 working in the market are left to work and potentially be filled.

In yet another alternative, the control routine 500 may determine that the user-requested modification is a quantity change. At block 546, the control routine 500 causes the parent quantity and the undisclosed quantity to be updated by the requested amount. The parent order modification subroutine 530 continues to block 548 where the control routine 500 evaluates the requested quantity change to determine if the total quantity has increased or decreased. If, as indicated at block 550, the change results in a quantity decrease and the quantity reduction is greater than the undisclosed quantity, then at block 552 the control routine 500 may implement a slicer quantity reduction process as disclosed in co-pending U.S. patent application Ser. No. 13/416,561, filed on Mar. 9, 2012 and titled “SLICING ORDER QUANTITY REDUCTION TOOL.” However if the amount of the quantity reduction is less than the undisclosed quantity, then at block 554 the quantity reduction is evaluated to determine if it is equal to the undisclosed quantity. If the two quantities are equal, then the control routine 500 at block 556 provides the user with an update. The update may, for example, indicate that no additional child orders 304 are necessary to complete the slicer order. Should the quantity change not equal the undisclosed quantity at block 554 or should the requested quantity change at block 548 represent a total quantity increase, then the control routine 500 executes the dynamic slicer plan recalculation subroutine 580 to address the remaining undisclosed quantity.

For example FIG. 6C depicts parent order modification request for the slicer order 600 of FIG. 6A. At 10:40 AM parent order modification request 662 is issued to decrease the quantity of the slicer order 600 from one hundred (100) units to ninety (90) units. At 10:40 AM the dynamic slicer order tool determines that there are still thirty (30) undisclosed units and the parent order was reduced by (10) units. In response to the undisclosed quantity being greater than the quantity change, the dynamic slicer order tool will reduce child order quantities 618 and 620 by five (5) units each to achieve the modified quantity of ninety (90) units. In another example, child order 620 could be canceled to achieve the modified order quantity of ninety (90) units.

In a different example FIG. 6D depicts parent order modification request for the slicer order 600 of FIG. 6A. At 10:40 AM parent order modification request 664 is issued to decrease the quantity of the slicer order 600 from one hundred (100) units to seventy (70) units. At 10:40 AM the dynamic slicer order tool determines that there are still thirty (30) undisclosed units and the parent order was reduced by (30) units. In response to the undisclosed quantity being equal to the quantity change, the dynamic slicer order tool will cancel all undisclosed child orders 616-620 to achieve the modified order quantity of seventy (70) units.

Under a different set of conditions, the control routine 500 may determine that the user-requested modification (see block 532) is intended to submit a held slicer order (i.e., a parent order) or simply resume the operation of (a previously paused) slicer order. If the slicer order is currently being held as indicated at block 540, the user-requested modification may direct the control routine 500 to immediately submit one or more of the child orders 304 to the market as shown at block 558. Similarly, if the slicer order is currently paused, then the user-requested modification may simply direct the control routine 500 to resume operation of the slicer order from the previously paused state.

Upon completion of the determination at block 554 or the submission function at block 558, the control routine 500 proceeds to the dynamic slicer plan recalculation subroutine 580 (see FIG. 5D).

FIG. 5D depicts the dynamic slicer plan recalculation subroutine 580 configured to analyze and replan the currently executing slicer order plan in response to the received modification request (see block 502). In operation, the dynamic slicer plan recalculation subroutine 580 is activated upon completion of either the parent order modification subroutine 530 or the child order modification subroutine 510. At block 582, the control routine 500 as implemented by the tool 400 determines whether or not the user modification request relates to a duration type slicer order or a non-duration type slicer order. If the slicer order is a non-duration type slicer, then at block 584 the control routine 500 simply recalculates the remaining slices in response to the user-requested modification. As described herein, non-durational slicer orders are handled and analyzed as if they were standard time and/or volume slicer orders. The dynamic slicer order scheduling module 408 and the dynamic slice order analysis module 410 may cooperate to replan the submission schedule to which the individual slices comprising the slicer plan are submitted to the market as a function of the interval, the disclosed quantity and the undisclosed quantity. Subsequently, as indicated at block 586, an update regarding the revised slicer plan may be provided to the user for review and/or confirmation via the GUI 300. Upon completion of the slicer plan update, the control routine at block 588 executes and implements the newly specified slicer plan.

Returning to block 582, the control routine 500 may determine that the slicer order is a duration type slicer, and then at block 590 the remaining time or period of the duration is calculated by, for example, the dynamic slicer order analysis module 410. Duration type slicer orders are, unlike non-duration type slicer orders, slicers that have a specified operating period or window (i.e., duration). Subsequently, at block 592 the dynamic slicer order analysis module 410 and the control routine 500 identify the user specified locked or fixed parameters such as the slicer interval or the disclosed quantity. If the user specified locked parameter specifies a desired interval, then the control routine 500 at block 594 calculates and replans the submission schedule and a new disclosed quantity as a function of the interval, the remaining time in the duration and the undisclosed quantity. Similarly, if the user-defined locked parameter specifies a particular disclosed quantity, then the control routine at block 596 calculates and replans the interval and submission schedule governing when the individual slices comprising the slicer order are submitted to the market as a function of the disclosed quantity, the remaining time in the duration and the undisclosed quantity. Upon completion of the replanning and recalculation processes described in connection with blocks 594 and 596, the control routine 500 may communicate an update regarding the revised slicer plan to the user for review and/or confirmation via the GUI 300. Subsequently, the control routine 500 at block 588 executes and implements the newly specified slicer plan.

In other embodiments, the GUI 300 may receive replanning information and generate a preview of how the user-requested changes affect the slicer order. In order to generate an accurate preview, the control routine 500 and/or the user may be required to provide the same seed for random number generation used when the order was created. By utilizing the same seed, the control routine 500 can recreate any induced order quantity or time variance defined when the slicer order was originally created. The defined variance can, in one or more embodiments, be introduced and/or maintained in the replanned slicer plan generated at blocks 584, 594, and 596.

Some of the described figures depict example block diagrams, systems, and/or flow diagrams representative of methods that may be used to implement all or part of certain embodiments. One or more of the components, elements, blocks, and/or functionality of the example block diagrams, systems, and/or flow diagrams may be implemented alone or in combination in hardware, firmware, discrete logic, as a set of computer readable instructions stored on a tangible computer readable medium, and/or any combinations thereof, for example.

The example block diagrams, systems, and/or flow diagrams may be implemented using any combination of application specific integrated circuit(s) (ASIC(s)), programmable logic device(s) (PLD(s)), field programmable logic device(s) (FPLD(s)), discrete logic, hardware, and/or firmware, for example. Also, some or all of the example methods may be implemented manually or in combination with the foregoing techniques, for example.

The example block diagrams, systems, and/or flow diagrams may be performed using one or more processors, controllers, and/or other processing devices, for example. For example, the examples may be implemented using coded instructions, for example, computer readable instructions, stored on a tangible computer readable medium. A tangible computer readable medium may include various types of volatile and non-volatile storage media, including, for example, random access memory (RAM), read-only memory (ROM), programmable read-only memory (PROM), electrically programmable read-only memory (EPROM), electrically erasable read-only memory (EEPROM), flash memory, a hard disk drive, optical media, magnetic tape, a file server, any other tangible data storage device, or any combination thereof. The tangible computer readable medium is non-transitory.

Further, although the example block diagrams, systems, and/or flow diagrams are described above with reference to the figures, other implementations may be employed. For example, the order of execution of the components, elements, blocks, and/or functionality may be changed and/or some of the components, elements, blocks, and/or functionality described may be changed, eliminated, sub-divided, or combined. Additionally, any or all of the components, elements, blocks, and/or functionality may be performed sequentially and/or in parallel by, for example, separate processing threads, processors, devices, discrete logic, and/or circuits.

The illustrations described herein are intended to provide a general understanding of the structure of various embodiments. The illustrations are not intended to serve as a complete description of all of the elements and features of apparatus, processors, and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be substantially minimized. Accordingly, the disclosure and the figures are to be regarded as illustrative rather than restrictive.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

What is claimed is:

1. A computer implemented method comprising:
receiving an order modification request for an executing slicer order at an interface portion of a computing device, wherein the slicer order executes according to a slicer order plan;
determining an order modification type for the order modification request utilizing a dynamic slicer tool executed by a processor portion of the computing device;
recalculating the slicer order plan utilizing the dynamic slicer tool;
generating a modified slicer order plan utilizing the dynamic slicer tool, wherein the dynamic slicer tool generates the modified slicer plan as a function of at least one of the order modification type and a locked parameter; and
executing the modified slicer plan utilizing the processor portion of the computing device, wherein the modified slicer plan replaces the currently executing slicer order plan.

2. The method as defined in claim 1, wherein the locked parameter is an interval, a disclosed quantity or an undisclosed quantity.

3. The method as defined in claim 1, wherein the element of the executing slicer order is selected from the group consisting of a parent order or at least one child orders.

4. The method as defined in claim 1, wherein calculating the revised slicer plan further includes calculating the revised slicer plan based on at least one slicer parameter selected from the group consisting of: an interval; a disclosed quantity; an undisclosed quantity; and a remaining duration period.

5. The method as defined in claim 1, wherein the component part of the executing slicer order includes a parent order and at least one child orders.

6. A method for managing an executing slicer order, including:
monitoring, by a computing device, an average fill price of the executing slicer order, wherein the executing slicer order includes a plurality of child orders implemented according to a slicer plan;
comparing, by the computing device, the average fill price of a first plurality of child orders with a limit price;
determining, by the computer device, an adjusted order price when that the average fill price of the first plurality is different than the limit price; and
implementing, by the computing device, a revised slicer plan that includes the adjusted order price for a second plurality of child orders.

7. The method of claim 6, wherein the first plurality of child orders have been filled.

8. The method of claim 6, wherein the second plurality of child orders are pending.

9. The method as defined in claim 6, wherein a user is notified of the adjusted order price.

10. The method as defined in claim 9, wherein the user approves implementing the revised slicer plan in accordance with the adjusted order price.

11. A method for managing an executing slicer order, including:
monitoring, by a computing device, an average fill price of a first plurality of child orders related to the executing slicer order;
comparing, by the computing device, the average fill price of the first plurality of child orders with a limit price;
determining, by the computer device, an adjusted order price when the average fill price is different than the limit price;
calculating, by the computer device, an adjusted order price when the average fill price of the first plurality is different than the limit price; and
executing, by the computing device, a second plurality of child orders in accordance with the adjusted order price.

12. The method of claim 11, wherein the first plurality of child orders have been filled.

13. The method of claim 11, wherein the second plurality of child orders are pending.

14. The method as defined in claim 11, wherein a user is notified of the adjusted order price.

15. The method as defined in claim 14, wherein the user approves implementing the revised slicer plan in accordance with the adjusted order price.

16. A gateway configured to:
receive an order modification request for an executing slicer order corresponding to a slicer order plan;
determine an order modification type for the order modification request;
recalculate the slicer order plan as a function of at least one of the order modification type and a locked parameter, wherein the result is a modified slicer order plan; and
implement the modified slicer order plan.

17. A non-transitory computer readable medium having stored therein instructions executable by a processor, wherein the instructions are executable to:
receive an order modification request for a first executing slicer order corresponding to a slicer order plan;
determine an order modification type for the order modification request;
recalculate the first slicer order plan as a function of at least one of the order modification type and a locked parameter, wherein the result is a second slicer order plan; and
implement the second slicer order plan.
